(19) United States
(12) Patent Application Publication
(10) Pub. No.: US 2021/0284786 A1
(43) Pub. Date: Sep. 16, 2021

(54) A FLEXIBLE FOAM FORMULATION AND METHOD OF PRODUCING THE SAME

(71) Applicant: BASF SE, Ludwigshafen am Rhein (DE)

(72) Inventors: Michele N. Williams-Harry, Wyandotte, MI (US); Steven E. Wujcik, Ann Arbor, MI (US); Willie G. Wesley, Wyandotte, MI (US)

(21) Appl. No.: 17/260,296

(22) PCT Filed: Jul. 19, 2019
(86) PCT No.: PCT/US2019/042565

§ 371 Date: Jan. 14, 2021

Related U.S. Application Data
(60) Provisional application No. 62/711,879, filed on Jul. 30, 2018.

(51) Int. Cl. C08G 18/76; C08G 18/80; C08G 18/48; C08G 18/28; C08J 9/12

(52) U.S. Cl. CPC C08G 18/7621; C08G 18/8064; C08G 18/4895; C08G 18/4833; C08G 18/288; C08G 2350/00; C08G 18/282; C08J 9/125; C08G 2110/0083; C08G 2110/005; C08G 2110/0008; C08G 18/285

(57) ABSTRACT

Modified 2,4-toluene diisocyanate (2,4-TDI) and 2,6-toluene diisocyanate (2,6-TDI) isomer mixtures and methods of producing the modified TDI isomer mixtures are provided. The modified TDI isomer mixture is a low-cost alternative to expensive commercially available TDI mixtures with high 2,6-TDI ratio, and produce a flexible PU foam with desirable foam properties.

### FIELD

The present application relates generally to a flexible polyurethane foam and a method of producing the flexible polyurethane foam. The present application also relates to a modified toluene diisocyanate isomer mixture for producing the flexible polyurethane foam and a method of producing the modified toluene diisocyanate isomer mixture.

### BACKGROUND

Polyurethanes (PU) are a broad class of materials that are used in a range of applications, including, but not limited to, foams, fibers, elastomers, coatings, and adhesives. PU foams exhibit a wide range of stiffness, hardness, and density. One type of PU foam, flexible PU foam, is especially useful for providing cushioning, support, and comfort for furniture, packaging, and components used in transportation.

Many flexible PU foams are produced via a reaction between a diisocyanate and an isocyanate-reactive component that includes one or more polyols. The mechanical properties of PU are directly influenced by the morphological relationship between the soft polyol segments alternating with hard, usually aromatic, isocyanate segments. Toluene diisocyanate (TDI) is typically used in flexible foams over other aromatic isocyanates because it is known to impart PU foams with desirable physical and mechanical properties, such as low resilience, soft touch, and slow recovery at low densities. TDI is primarily commercially available as three mixtures of the 2,4 and 2,6 isomers in ratios of 65/35 (T65), 80/20 (T80), and 100/0 (T100). Changes in morphology and dynamic mechanical behavior of flexible polyurethane foams made from TDI are known in the art to be specially dependent on the variable contents of the 2,4- and 2,6-TDI isomers. Foams made with higher concentrations of the 2,6-TDI isomers have been reported to have more loading bearing capacity, as well as open cell structure over foams made with higher ratios of 2,4-isomer. Aneja, et al. (2003) J. Polym. Sci. Part B: Polym. Phys. 41:258-268. Unfortunately, the pure 2,6-TD1 isomer is prohibitively expensive compared to the pure 2,4-TDI isomer. Combinations of the commercially available T65 and T80 TDI isomer mixtures are therefore commonly used to obtain flexible PU foams with good quality. There are limited commercial suppliers for the T65 TDI isomer mixtures. When supplies of 65/35 TDI monomer are low, a low-cost alternative is not available with comparable performance.

Therefore, what is needed is a low-cost alternative to the commercial supplies with high 2,6-TDI contents (35 wt % 2,6-TDI, 65 wt % 2,4-TDI), which can impart good flexible PU foam properties.

### SUMMARY

Embodiments of the present disclosure include a modified TDI isomer mixture and a method of producing the modified TDI isomer mixture. 2,4-TDI in the TDI isomer mixture is deactivated by capping the 4-isocyanate using a capping agent. As a result, the apparent ratio of 2,6-TDI in the modified TDI mixture is increased. The modified TDI isomer mixture is used to replace expensive commercially available TDI mixtures with higher 2,6-TDI ratio, and produce a flexible PU foam with good foam properties.

In one embodiment, a method of producing polyurethane is disclosed, the method comprises modifying a 2,4-TDI/2,6-TDI mixture using a capping agent, and reacting the modified TDI mixture with an isocyanate-reactive component, wherein the capping agent comprises a monoalcohol, a monoamine or a monothiol. In another embodiment, a polyurethane product is disclosed, which is produced by a method comprising modifying a 2,4-TDI and 2,6-TDI mixture using a capping agent, and reacting the modified TDI mixture with an isocyanate-reactive component, wherein the capping agent comprises a monoalcohol, a monoamine or a monothiol.

In certain embodiment, a method of modifying a 2,4-TDI/2,6-TDI mixture is disclosed, the method comprises reacting a capping agent with the TDI isomer mixture, wherein the capping agent comprises a monoalcohol, a monoamine or a monothiol. In a specific embodiment, a modified TDI isomer mixture is disclosed, which is produced by a method comprising reacting a capping agent comprising a monoalcohol, a monoamine or a monothiol with the TDI isomer mixture.

In a specific embodiment, the ratio of 2,4-TDI to 2,6-TDI in the mixture may be about 65 to 35 or about 80 to 20. In another embodiment, the capping agent may be methanol, ethanol, 1-propanol, isopropanol, 1-butanol, 2-butanol, 1-pentanol, 2-pentanol, 1-hexanol, 2-hexanol, cyclohexanol, 1-heptanol, 2-heptanol, 1-octanol, 2-octanol, 1-nonanol, 1-decanol, 1-undecanol, or 1-dodecanol.

Other features and advantages will become apparent from the following detailed description and drawing.

### BRIEF DESCRIPTION OF THE DRAWING

In order to facilitate a fuller understanding of the present disclosure, reference is now made to the accompanying drawing, in which like elements are referenced with like numerals. These drawing should not be construed as limiting the present disclosure, but are intended to be illustrative only.

FIG. 1 depicts a flow chart of a method of producing flexible polyurethane foam in accordance with an embodiment of the present disclosure.

### DETAILED DESCRIPTION

As used herein, the terminology “flexible polyurethane foam” denotes a class of flexible polyurethane foam and stands in contrast to rigid polyurethane foam. Flexible polyurethane foam is generally porous, having open cells and pneumatic properties, whereas rigid polyurethane foam is generally non-porous, having closed cells and no rubber-like characteristics. In particular, flexible polyurethane foam is a flexible cellular product which will not rupture when a specimen 200 mm by 25 mm by 25 mm is bent around a 25-mm diameter mandrel at a uniform rate of 1 lap in 5 seconds at a temperature between 18 and 29° C., as defined by ASTM D3574-03. Further, polyol selection impacts the stiffness of flexible polyurethane foams. That is, flexible polyurethane foams are typically produced from polyols having weight average molecular weights from about 1,000 to about 10,000 g/mol and hydroxyl numbers from about 10 to about 200 mg KOH/g. In contrast, rigid polyurethane foams are typically produced from polyols having weight average molecular weights from about 250 to about 700 g/mol and hydroxyl numbers from about 300 to about 700 mg KOH/g. Moreover, flexible polyurethane foams generally include more urethane linkages as compared to rigid polyurethane foams, whereas rigid polyurethane foams may include more isocyanurate linkages as compared to flexible polyurethane foams. Further, flexible polyurethane foams are typically produced from polyols having low-functionality (f) initiators, i.e., f<4, such as dipropylene glycol (f=2) or glycerine (f=3). By comparison, rigid polyurethane foams are typically produced from polyols having high-functionality initiators, i.e., f>4, such as Mannich bases (f=4), toluenediamine (f=4), sorbitol (f=6), or sucrose (f=8). Additionally, as known in the art, flexible polyurethane foams are typically produced from glycerine-based polyether polyols, whereas rigid polyurethane foams are typically produced from polyfunctional polyols that create a three-dimensional cross-linked cellular structure, thereby increasing the stiffness of the rigid polyurethane foam. Finally, although both flexible polyurethane foams and rigid polyurethane foams include cellular structures, flexible polyurethane foams typically include more open cell walls, which allow air to pass through the flexible polyurethane foam when force is applied as compared to rigid polyurethane foams. As such, flexible polyurethane foams typically recover shape after compression. In contrast, rigid polyurethane foams typically include more closed cell walls, which restrict air flow through the rigid polyurethane foam when force is applied. Therefore, flexible polyurethane foams are typically useful for cushioning and support applications, e.g. furniture comfort and support articles, whereas rigid polyurethane foams are typically useful for applications requiring thermal insulation, e.g. appliances and building panels.

The flexible polyurethane foam of the present disclosure comprises the reaction product of a TDI isomer mixture modified by a capping agent and an isocyanate-reactive component. In one embodiment, the capping agent may be a mono-alcohol with a number of carbon atoms from 1 to 30. The mono-alcohol can be linear, branched, or cyclic. In a specific embodiment, the capping agent may be methanol, ethanol, 1-propanol, isopropanol, 1-butanol, 2-butanol, 1-pentanol, 2-pentanol, 1-hexanol, 2-hexanol, cyclohexanol, 1-heptanol, 2-heptanol, 1-octanol, 2-octanol, 1-nonanol, 1-decanol, 1-undecanol, 1-dodecanol, 1-tridecanol, 1-tetradecanol, 1-pentadecanol, cetyl alcohol, 1-heptadecanol, stearyl alcohol, 1-nonadecanol, arachidyl alcohol, 1-heneicosanol, 1-docosanol, 1-tricosanol, 1-tetracosanol, 1-pentacosanol, 1-hexacosanol, 1-heptacosanol, 1-octacosanol, 1-nonacosanol, or 1-triacontanol.

In another embodiment, the capping agent may be a mono-thiol with a number of carbon atoms from 1 to 30. The mono-thiol can be linear, branched, or cyclic. In a specific embodiment, the capping agent can be methanethiol, ethanethiol, 1-propanethiol, 2-propanethiol, 1-butanethiol, 2-butanethiol, 1-pentanethiol, 2-pentanethiol, 1-hexanethiol, 2-hexanethiol, cyclohexanethiol, 1-heptanethiol, 2-heptanethiol, 1-octanethiol, 2-octanethiol, 1-nonanethiol, 1-decanethiol, 1-undecanethiol, 1-dodecanethiol, 1-tridecanethiol, 1-tetradecanethiol, 1-pentadecanethiol, cetyl mercaptan, 1-heptadecanethiol, 1-octadecanethiol, 1-nonadecanethiol, arachidyl thiol, 1-heneicosanethiol, 1-docosanethiol, 1-tricosanethiol, 1-tetracosanethiol, 1-pentacosanethiol, 1-hexacosanethiol, 1-heptacosanethiol, 1-octacosanethiol, 1-nonacosanethiol, or 1-triacontanethiol.

In yet another embodiment, the capping agent may be a mono-amine with a number of carbon atoms from 1 to 30. The mono-amine can be linear, branched, or cyclic. In a specific embodiment, the capping agent can be methylamine, ethylamine, propylamine, butylamine, pentylamine, hexylamine, cyclohexylamine, heptylamine, octylamine, nonylamine, decylamine, undecylamine, dodecylamine, 1-tridecanamine, 1-tetradecanamine, 1-pentadecanamine, cetyl amine, 1-heptadecanamine, 1-octadecanamine, 1-nonadecanamine, arachidyl amine, 1-heneicosanamine, 1-docosanamine, 1-tricosanamine, 1-tetracosanamine, 1-pentacosanamine, 1-hexacosanamine, 1-heptacosanamine, 1-octacosanamine, 1-nonacosanamine, or 1-triacontanamine.

Modifying the TDI isomer mixture with a capping agent may be carried out in the presence of a solvent or in the absence of a solvent. If desired, suitable solvents include, but are not limited to, organic solvents, such as toluene, xylene, benzene, tetrahydrofuran, dimethylformamide, acetone, diethyl ether, ethyl acetate, hexane, cyclohexane, 1,4-dioxane, chloroform, dichloromethane, acetonitrile, dimethyl sulfoxide, and propylene carbonate. In certain embodiments, the reaction of TDI isomer mixture and capping agent is carried out in the absence of any solvent.

The TDI isomer mixture modifying reaction may be carried out in the absence of catalyst or in the present of catalyst. Exemplary catalysts include, but are not limited to, N,N-dimethylethanolamine (DMEA), N,N-dimethylcyclohexylamine (DMCHA), bis(N,N-dimethylaminoethyl)ether (BDMAFE), N,N,N′,N′,N″-pentamethyldiethylenetriamine (PDMAFE), 1,4-diazadicyclo[2,2,2]octane (DABCO), 2-(2-dimethylaminoethoxy)-ethanol (DMAFE), 2-((2-dimethylaminoethoxy)-ethyl methyl-amino)ethanol, 1-(bis(3-dimethylamino)-propyl)amino-2-propanol, N,N′,N″-tris(3-dimethylamino-propyl)hexahydrotriazine, dimorpholinodiethylether (DMDEE), N,N-dimethylbenzylamine, N,N,N′,N″,N″-pentaamethyldipropylenetriamine, N,N′-diethylpiperaztne, and etc. In particular, sterically hindered primary, secondary or tertiary amines can be used, including, but are not limited to, dicyclohexylmethylamine, ethyldiisopropylamine, dimethylcyclohexylamine, dimethylisopropylamine, methylisopropylbenzylamine, methylcyclopentylbenzylamine, isopropyl-sec-butyl-trifluoroethylamine, diethyl-(o-phenyethyl) amine, tri-n-propylamine, dicyclohexylamine, t-butylisopropylamine, di-t-butylamine, cyclohexyl-t-butylamine, de-sec-butylamine, dicyclopentylamine, di-(a-trifluoromethylethyl) amine, di-(α-phenylethyl) amine, triphenylmethylamine, and 1,1,-diethyl-n-propylamine. Other sterically hindered amines are morpholines, imidazoles, ether containing compounds such as dimorpholinodiethylether, N-ethylmorpholine, N-methylmorpholine, bis(dimethylaminoefhyl)ether, imidizole, n-methylimidazole, 1,2-dimethylimidazole, dimorpholinodimethylether, N,N,N′,N′,N″,N″-pentamethyldiethylenetriamine, N,N,N′,N,N″,N″-pentamethyldipropylenetriamine, bis(diethylaminoethyl)ether, bis(dimethylaminopropyl)ether, or combinations thereof. Non-amine catalysts include, but are not limited to, stannous octoate, dibutyltin dilaurate, dibutyltin mercaptide, phenylmercuric propionate, lead octoate, potassium acetate/octoate, quaternary ammonium formates, ferric acetylacetonate and mixtures thereof. The use level of the catalysts can be in an amount of about 0.05 to about 4.00 wt % of polyol premix, from about 0.15 to about 3.60 wt %, or from about 0.40 to about 2.60 wt %. In a specific embodiment, the TDI mixture modifying reaction is carried out without a catalyst.

The TDI isomer mixture modifying reaction may be carried out at a temperature of about −80° C. to about 100° C., about −70° C. to about 90° C., about −60° C. to about 80° C., about −50° C. to about 70° C., about −40° C. to about 60° C., about −30° C. to about 50° C., about −20° C. to about 40° C., about −10° C. to about 30° C., about −80° C. to about 30° C., or about −10° C. to about 100° C. In a specific embodiment, the TDI mixture modifying reaction may be carried out at room temperature, which is about 20 to about 23° C.

The TDI isomer mixture modifying reaction may be carried out in an ambient atmosphere, an argon atmosphere, or a nitrogen atmosphere. In a specific embodiment, the TDI mixture modifying reaction is carried out at a nitrogen atmosphere. In the TDI mixture modifying reaction, the TDI isomer mixture component may be added to the capping agent component, or the capping agent component can be added to the TDI mixture component. In a specific embodiment, the capping agent is added to the TDI isomer mixture. The addition time can vary depending on the scale of the reaction, ranging from about 1 minute to about 10 hours. In a certain embodiment, the reaction temperature may be monitored during addition and the temperature is maintained below about 40° C. The modified TDI isomer mixture may be purified or directly used for producing flexible PU foams.

While not wishing to be bound by any particular theory, compared to 2-isocyanate, the 4-isocyanate in 2,4-TDI is more reactive with the capping agent at least due to its favorable steric hindrance. Once the 4-isocyanate reacts with the capping agent to form carbamate (using monoalcohol as a capping agent), urea (using monoamine as a capping agent), or thiocarbamate (using monothiol as a capping agent), these functional groups are less electron-withdrawing compared to the pristine isocyanate group. This further deactivates the leftover 2-isocyanate in the capped 2,4-TDI. As a result, the apparent ratio of 2,6-TDI is increased in the modified TDI isomer mixture, which provides a low-cost alternative to the commercially expensive T65.

The modified TDI isomer mixture may be directly used to produce a flexible polyurethane foam or stored for future use. The modified TDI can be used with another isocyanate component to produce a polyurethane-type product. The isocyanate component may include, but is not limited to, isocyanates, diisocyanates, polyisocyanates, biurets of isocyanates and polyisocyanates, isocyanurates of isocyanates and polyisocyanates, and combinations thereof. In one embodiment, the isocyanate component includes an n-functional isocyanate, wherein “n” may be a number from 2 to 5, from 2 to 4, or from 3 to 4. It is to be understood that “n” may be an integer or may have intermediate values from 2 to 5. The isocyanate component may include an isocyanate selected from the group of aromatic isocyanates, aliphatic isocyanates, and combinations thereof. In an embodiment, the isocyanate component includes an aliphatic isocyanate such as hexamethylene diisocyanate, H12MDI, and combinations thereof. If the isocyanate component includes an aliphatic isocyanate, the isocyanate component may also include a modified multivalent aliphatic isocyanate, i.e., a product which is obtained through chemical reactions of aliphatic diisocyanates and/or aliphatic polyisocyanates. Examples include, but are not limited to, ureas, biurets, allophanates, carbodiimides, uretonimines, isocyanurates, urethane groups, dimers, trimers, and combinations thereof. The isocyanate component may also include, but is not limited to, modified diisocyanates employed individually or in reaction products with polyoxyalkyleneglycols, diethylene glycols, dipropylene glycols, polyoxyethylene glycols, polyoxypropylene glycols, polyoxypropylenepolyoxethylene glycols, polyesterols, polycaprolactones, and combinations thereof.

Alternatively, the isocyanate component may include an aromatic isocyanate. If the isocyanate component includes an aromatic isocyanate, the aromatic isocyanate may correspond to the formula R(NCO), wherein R′ is aromatic and z is an integer that corresponds to the valence of R′. Preferably, z is at least two. Suitable examples of aromatic isocyanates include, but are not limited to, tetramethylxylylene diisocyanate (TMXDI), 1,4-diisocyanatobenzene, 1,3-diisocyanato-o-xylene, 1,3-diisocyanato-p-xylene, 1,3-diisocyanato-m-xylene, 2,4-diisocyanato-1-chlorobenzene, 2,4-diisocyanato-1-nitro-benzene, 2,5-diisocyanato-1-nitrobenzene, m-phenylene diisocyanate, p-phenylene diisocyanate, 2,4-toluene diisocyanate, 2,6-toluene diisocyanate, mixtures of 2,4- and 2,6-toluene diisocyanate, 1,5-naphthalene diisocyanate, 1-methoxy-2,4-phenylene di isocyanate, 4,4′-diphenylmethane diisocyanate, 2,4′-diphenylmethane diisocyanate, 4,4′-biphenylene diisocyanate, 3,3′-dimethyl-4,4′-diphenylmethane diisocyanate, 3,3′-dimethyldiphenylmethane-4,4′-diisocyanate, triisocyanates such as 4,4′,4″-triphenylmethane triisocyanate polymethylene polyphenylene polyisocyanate and 2,4,6-toluene triisocyanate, tetraisocyanates such as 4,4′-dimethyl-2,2′-5,5′-diphenylmethane tetraisocyanate, toluene diisocyanate, 2,2′-diphenylmethane diisocyanate, 2,4′-diphenylmethane diisocyanate, 4,4′-diphenylmethane diisocyanate, polymethylene polyphenylene polyisocyanate, corresponding isomeric mixtures thereof, and combinations thereof. Alternatively, the aromatic isocyanate may include a triisocyanate product of m-TMXDI and 1,1,1-trimethylolpropane, a reaction product of toluene diisocyanate and 1,1,1-trimethyolpropane, and combinations thereof. In one embodiment, the isocyanate component includes a diisocyanate selected from the group of methylene diphenyl diisocyanates, toluene diisocyanates, hexamethylene diisocyanates, H12MDIs, and combinations thereof.

The isocyanate component may have any % NCO content and any viscosity. The isocyanate component may also react with the resin and/or chain extender in any amount, as determined by one skilled in the art. Preferably, the isocyanate component and the resin and/or chain extender are reacted at an isocyanate index from 15 to 900, more preferably from 95 to 130, and alternatively from 105 to 130. In one embodiment, commercially available isocyanates can be used. In a specific embodiment, the isocyanates used in this disclosure can be under the trade names Lupranate® or Basonat® from BASF Group. In certain embodiment, the isocyanates used in this disclosure can be under the trade name Desmodur®, Mondur® or Sumidur® from Covestro of Pittsburgh, Pa.

The isocyanate-reactive component of the present disclosure may include one or more of a polyether polyol, a polyester polyol, and combinations thereof. As is known in the art, polyether polyols are typically formed from a reaction of an initiator and an alkylene oxide. Preferably, the initiator is selected from the group of aliphatic initiators, aromatic initiators, and combinations thereof. In one embodiment, the initiator is selected from the group of ethylene glycol, propylene glycol, dipropylene glycol, butylene glycol, trimethylene glycol, 1,2-butanediol, 1,3-butanediol, 1,4-butanediol, 1,2-pentanediol, 1,4-pentanediol, 1,5-pentanediol, 1,6-hexanediol, 1,7-heptanediol, butenediol, butynediol, xylylene glycols, amylene glycols, 1,4-phenylene-bis-beta-hydroxy ethyl ether, 1,3-phenylene-bis-beta-hydroxy ethyl ether, bis-(hydroxy-methyl-cyclohexane), thiodiglycol, glycerol, 1,1,1-trimethylolpropane, 1,1,1-trimethylolethane, 1,2,6-hexanetriol, .alpha.-methyl glucoside, pentaerythritol, sorbitol, aniline, o-chloroaniline, p-aminoaniline, 1,5-diaminonaphthalene, methylene dianiline, the condensation products of aniline and formaldehyde, 2,3-, 2,6-, 3,4-, 2,5-, and 2,4-diaminotoluene and isomeric mixtures, methylamine, tri isopropanolamine, ethylenediamine, 1,3-diaminopropane, 1,3-diaminobutane, 1,4-diaminobutane, propylene diamine, butylene diamine, hexamethylene diamine, cyclohexalene diamine, phenylene diamine, tolylene diamine, xylylene diamine, 3,3′-dichlorobenzidine, 3,3′- and dinitrobenzidine, alkanol amines including ethanol amine, aminopropyl alcohol, 2,2-dimethyl propanol amine, 3-aminocyclohexyl alcohol, and p-aminobenzyl alcohol, and combinations thereof. It is contemplated that any suitable initiator known in the art may be used in the present disclosure.

Preferably, the alkylene oxide that reacts with the initiator to form the polyether polyol is selected from the group of ethylene oxide, propylene oxide, butylene oxide, amylene oxide, tetrahydrofuran, alkylene oxide-tetrahydrofuran mixtures, epihalohydrins, aralkylene oxides, and combinations thereof. More preferably, the alkylene oxide is selected from the group of ethylene oxide, propylene oxide, and combinations thereof. Most preferably, the alkylene oxide includes ethylene oxide. However, it is also contemplated that any suitable alkylene oxide that is known in the art may be used in the present disclosure.

The polyether polyol may include an ethylene oxide cap of from 5 to 20% by weight based on the total weight of the polyether polyol. Without intending to be bound by any particular theory, it is believed that the ethylene oxide cap promotes an increase in a rate of the reaction of the polyether polyol and the isocyanate.

The polyether polyol may also have a number average molecular weight of from 18 to 10,000 g/mol. Further, the polyether polyol may have a hydroxyl number of from 15 to 6,250 mg KOH/g. The polyether polyol may also have a nominal functionality of from 2 to 8. Further, further, the polyether polyol may also include an organic functional group selected from the group of a carboxyl group, an amine group, a carbamate group, an amide group, and an epoxy group.

Referring now to the polyester polyols introduced above, the polyester polyols may be produced from a reaction of a dicarboxylic acid and a glycol having at least one primary hydroxyl group. Suitable dicarboxylic acids may be selected from the group of, but are not limited to, adipic acid, methyl adipic acid, succinic acid, suberic acid, sebacic acid, oxalic acid, glutaric acid, pimelic acid, azelaic acid, phthalic acid, terephthalic acid, isophthalic acid, and combinations thereof. Suitable glycols include, but are not limited to, those described above.

The polyester polyol may also have a number average molecular weight of from 80 to 1500 g/mol. Further, the polyester polyol may have a hydroxyl number of from 40 to 600 mg KOH/g. The polyester polyol may also have a nominal functionality of from 2 to 8. Further, the polyester polyol may also include an organic functional group selected from the group of a carboxyl group, an amine group, a carbamate group, an amide group, and an epoxy group. In one embodiment, the polyols used in this disclosure can be under the trade names Lupraphen® or Fomrez from BASF Group.

In certain embodiments, the isocyanate-reactive component further comprises a graft polyol, which denotes dispersed polymer solids chemically grafted to a carrier polyol. The graft polyol of the isocyanate-reactive component comprises a carrier polyol and particles of co-polymerized styrene and acrylonitrile, wherein the particles of co-polymerized styrene and acrylonitrile are dispersed in the carrier polyol, as set forth in more detail below. Typically, the carrier polyol of the graft polyol is a polyether polyol. The graft polyol typically has a functionality of from about 2 to about 4, more typically from about 2.5 to about 3.5.

In a specific embodiment, the carrier polyol of the graft polyol can be a polyether polyol. The carrier polyol can be any known polyether polyol in the art and preferably serves as a continuous phase for the dispersed co-polymerized styrene and acrylonitrile particles. That is, the co-polymerized styrene and acrylonitrile particles are dispersed in the carrier polyol to form a dispersion, i.e., to form the graft polyol. In certain embodiments, the carrier polyol is a polyether triol having a molecular weight of from about 700 to about 20,000, more typically from about 1,000 to about 5,000, and more typically from about 2,000 to about 4,000. The carrier polyol typically has the molecular weight so as to provide the flexible polyurethane foam with flexibility and a desired density, as described in greater detail below. The molecular weight of the carrier polyol typically provides randomly-sized, irregular-shaped cells, e.g., cells that differ in both size and shape from neighboring cells.

The particles of co-polymerized styrene and acrylonitrile can be dispersed in the carrier polyol in an amount of from about 30 to about 60, typically from about 40 to about 55, more typically from about 42 to about 50, and even more typically about 44 parts by weight of particles based on 100 parts by weight of the carrier polyol. An example of a carrier polyol having the particles of co-polymerized styrene and acrylonitrile dispersed therein in an amount of 44 parts by weight based on 100 parts by weight of the carrier polyol is Pluracol® 4600, commercially available from BASF Group.

Flame retardant additives can be used to produce flexible polyurethane foams exhibiting flame retardance. For example, flame retardant additives including minerals, such as aluminum trihydrate; salts, such as hydroxymethyl phosponium salts; phosphorous compounds; phosphated esters; and halocarbons or other halogenated compounds, such as those containing bromine and/or chlorine; can be included in the isocyanate-reactive component.

While not wishing to be bound by theory, the graft polyol can be present in the isocyanate-reactive component to provide the flexible polyurethane foam with an optimal cross-sectional density and to adjust the solids level of the flexible polyurethane foam. The graft polyol also can contribute to the processability and hardness of the flexible polyurethane foam. The graft polyol also allows for optimal cell opening during production of the flexible polyurethane foam without having any adverse effects on the resilience of the flexible polyurethane foam. Further, it is believed that the graft polyol affects the flame retardance of the flexible polyurethane foam of the present disclosure. When present, the graft polyol can be present in the isocyanate-reactive component in an amount of from greater than 0 to 100, more typically from about 5 to about 50, even more typically from about 10 to about 30 parts by weight (PB W) based on 100 parts by weight of total polyol present in the isocyanate-reactive component. When the graft polyol is present in the isocyanate-reactive component in an amount of 100 parts by weight, the isocyanate-reactive component still comprises polyether polyol as the carrier polyol in the graft polyol. The carrier polyol of the graft polyol may comprise the polyether triol illustrated and described above. Additionally, the graft polyol typically has hydroxyl number of from about 10 to about 60, more typically from about 20 to about 40 mg KOH/g. Further, the graft polyol typically has a viscosity of from about 1,000 to about 7,000 centipoise at 25° C., which allows for processing efficiencies such as ease of component mixing, thereby contributing to the cost effectiveness of producing the flexible polyurethane foam.

A cross-linking agent having a nominal functionality of less than 4 can be used to produce the flexible polyurethane foam in the instant disclosure. In one embodiment, the cross-linking agent can be used in the isocyanate-reactive component. The cross-linking agent generally can allow phase separation between copolymer segments of the flexible polyurethane foam. That is, the flexible polyurethane foam typically comprises both rigid urea copolymer segments and soft polyol copolymer segments. The cross-linking agent typically chemically and physically links the rigid urea copolymer segments to the soft polyol copolymer segments. Therefore, the cross-linking agent is typically present in the isocyanate-reactive component to modify the hardness, increase stability, and reduce shrinkage of the flexible polyurethane foam. When utilized, the cross-linking agent can be present in the isocyanate-reactive component in an amount of from greater than zero to about 2, more typically from about 0.1 to about 1 parts by weight based on 100 parts by weight of total polyol present in the isocyanate-reactive component. In one embodiment, the cross-linking agent can comprise diethanolamine.

A catalyst component may be used to produce the flexible polyurethane foam in the current disclosure. In a specific embodiment, the catalyst component may be present in the isocyanate-reactive component to catalyze the flexible polyurethane foaming reaction between the isocyanate component and the isocyanate-reactive component. It is to be appreciated that the catalyst component is typically not consumed to form the reaction product of the isocyanate component and the isocyanate-reactive component. That is, the catalyst component typically participates in, but is not consumed by, the flexible polyurethane foaming reaction. When utilized, the catalyst component can be present in the isocyanate-reactive component in an amount of from greater than 0 to about 2, more typically from about 0.10 to about 1 parts by weight based on 100 parts by weight of total polyol present in the isocyanate-reactive component. The catalyst component may include any suitable catalyst or mixtures of catalysts known in the art. Examples of suitable catalysts include, but are not limited to, gelation catalysts, e.g. crystalline catalysts in dipropylene glycol; blowing catalysts, e.g. bis(dimethylaminoethyl)ether in dipropylene glycol; and tin catalysts, e.g. tin octoate. A suitable catalyst component for purposes of the present disclosure is Dabco™ NE400, commercially available from Air Products of Trexlertown, Pa.

In certain embodiments, a cell opening additive may be used to produce the flexible polyurethane foam in the present disclosure. In a specific embodiment, the cell opening additive can be used in the isocyanate-reactive component. Typically, the cell opening additive is a di-substituted aliphatic ester having the following formula:

R¹—OCO—R²—COO—R¹

wherein R¹ can be an independently selected alkyl group having from 1 to 4 carbon atoms and R² can be a bivalent alkyl group having from 2 to 6 carbon atoms. Specific examples of cell opening additives include, but are not limited to, dimethyl adipate, dimethyl glutarate, dimethyl succinate, dibasic ester, and combinations thereof. Dimethyl adipate is commercially available from Dow Chemical Company of Midland, Mich.

An additive component may be further used to produce the flexible polyurethane foam in the present disclosure. In a specific embodiment, the additive component may be used in the isocyanate-reactive component. The additive component can be selected from the group of surfactants, blocking agents, dyes, pigments, diluents, solvents, specialized functional additives such as antioxidants, ultraviolet stabilizers, biocides, adhesion promoters, antistatic agents, mold release agents, fragrances, and combinations of the group. When utilized, the additive component can be present in the isocyanate-reactive component in an amount of from greater than 0 to about 15, more typically from about 1 to about 10 parts by weight based on 100 parts of total polyol present in the isocyanate-reactive component.

The additive component may comprise a surfactant, which can be used to control cell structure of the flexible polyurethane foam and to improve miscibility of components and flexible polyurethane foam stability. Suitable surfactants include any surfactant known in the art, such as silicones and nonylphenol ethoxylates. In one embodiment, the surfactant can be a silicone. In a specific embodiment, the silicone is typically a polydimethylsiloxane-polyoxyalkylene block copolymer. The surfactant can be selected according to the reactivity of the polyether polyol and/or the graft polyol, if present in the isocyanate-reactive component. When utilized, the surfactant can be present in the isocyanate-reactive component in an amount of from about 0.5 to about 2 parts by weight based on 100 parts by weight of total polyol present in the isocyanate-reactive component. A specific example of a surfactant for the purposes of the present disclosure is Tegostab® B8330, commercially available from Evonik Industries of Parsippany, N.J.

The additive component may also comprise emulsifiers, which can promote uniform distribution of porosity and density in the final foam. In one embodiment, any surfactants discussed above can be used as emulsifiers. In a specific embodiment, Tegostab® B8315 may be used as an emulsifier, commercially available from Evonik Industries of Parsippany, N.J.

The additive component may further comprise a blocking agent. The blocking agent can be used to delay cream time and increase cure time of the flexible polyurethane foam. Suitable blocking agents include any blocking agent known in the art. In a specific embodiment, the blocking agent may be a polymeric acid, i.e., a polymer with repeating units and multiple acid-functional groups. One skilled in the art typically selects the blocking agent according to the reactivity of the isocyanate component.

The isocyanate component and the isocyanate-reactive component may be reacted in the presence of a blowing agent to produce the flexible polyurethane foam. As is known in the art, during the flexible polyurethane foaming reaction between the isocyanate component and the isocyanate-reactive component, the blowing agent promotes the release of a blowing gas which forms cell voids in the flexible polyurethane foam. The blowing agent may be a physical blowing agent, a chemical blowing agent, or a combination of a physical blowing agent and chemical blowing agent.

The terminology physical blowing agent refers to blowing agents that do not chemically react with the isocyanate component and/or the isocyanate-reactive component to provide the blowing gas. The physical blowing agent can be a gas or liquid. The liquid physical blowing agent typically evaporates into a gas when heated, and typically returns to a liquid when cooled. The physical blowing agent typically reduces the thermal conductivity of the flexible polyurethane foam. Suitable physical blowing agents for the purposes of the subject disclosure may include liquid carbon dioxide (CO₂), acetone, methyl formate, and combinations thereof. The most typical physical blowing agents typically have a zero ozone depletion potential.

The terminology chemical blowing agent refers to blowing agents which chemically react with the isocyanate component or with other components to release a gas for foaming. Examples of chemical blowing agents that are suitable for the purposes of the subject disclosure include formic acid, water, and combinations thereof. The blowing agent is typically present in the isocyanate-reactive component in an amount of from about 0.5 to about 20 parts by weight based on 100 parts by weight of total polyol present in the isocyanate-reactive component. In certain embodiments, a combination of chemical and physical blowing agents is utilized, such as water and liquid CO₂.

The present disclosure also provides a method of producing the flexible polyurethane foam. The method of producing the flexible polyurethane foam comprises the steps of providing the isocyanate component, providing the isocyanate-reactive component, and reacting the isocyanate component with the isocyanate-reactive component to produce the flexible polyurethane foam. The method may further comprise the steps of providing the catalyst component and reacting the isocyanate component with the isocyanate-reactive component in the presence of the catalyst component to produce the flexible polyurethane foam.

The isocyanate component and the isocyanate-reactive component are typically reacted at an isocyanate index of greater than or equal to about 90, more typically greater than or equal to about 100, even more typically about 110. The terminology isocyanate index is defined as the ratio of NCO groups in the isocyanate component to hydroxyl groups in the isocyanate-reactive component multiplied by 100. The flexible polyurethane foam of the present disclosure may be produced by mixing the isocyanate component and the isocyanate-reactive component to form a mixture at room temperature or at slightly elevated temperatures, e.g. 15 to 30° C. It certain embodiments in which the flexible polyurethane foam is produced in a mold, it is to be appreciated that the isocyanate component and the isocyanate-reactive component may be mixed to form the mixture prior to disposing the mixture in the mold. For example, the mixture may be poured into an open mold or the mixture may be injected into a closed mold. Alternatively, the isocyanate component and the isocyanate-reactive component may be mixed to form the mixture within the mold. In these embodiments, upon completion of the flexible polyurethane foaming reaction, the flexible polyurethane foam takes the shape of the mold. The flexible polyurethane foam may be produced in, for example, low pressure molding machines, low pressure slabstock conveyor systems, high pressure molding machines, including multi-component machines, high pressure slabstock conveyor systems, and/or by hand mixing.

In certain embodiments, the flexible polyurethane foam may be produced or disposed in a slabstock conveyor system, which can form flexible polyurethane foam having an elongated rectangular or circular shape. As known in the art, slabstock conveyor systems can include mechanical mixing head for mixing individual components, e.g. the isocyanate component and the isocyanate-reactive component, a trough for containing a flexible polyurethane foaming reaction, a moving conveyor for flexible polyurethane foam rise and cure, and a fall plate unit for leading expanding flexible polyurethane foam onto the moving conveyor.

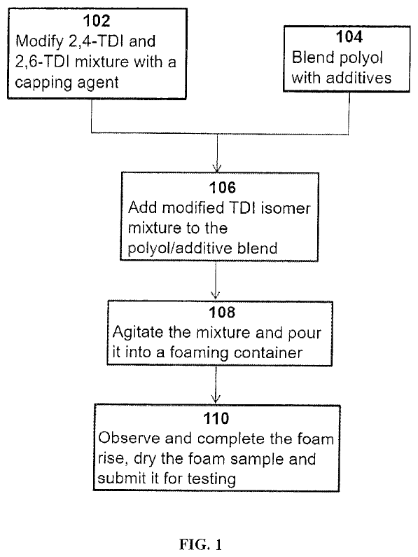

FIG. 1 depicts a flow chart of a method of producing flexible polyurethane foam in accordance with an embodiment of the present disclosure. In step 102, the TDI isomer mixture is modified using a capping agent. In step 104, isocyanate-reactive component such as polyol is blended with additives. In step 106, the modified isomer mixture is added to the polyol/additive blend. Step 108 agitates the resulting mixture, which is then poured into a foaming container. Step 110 observes the foam rise to complete, the foam sample is then dried and submitted for testing.

The density of the flexible polyurethane foam of the present disclosure may be determined at 68° C. and 50% relative humidity (RH), in accordance with ASTM D1622. The flexible polyurethane foam of the present disclosure ca may have a density of from about 1.0 to about 4.0, about 1.5 to about 3.5, or about 2 to about 3 pounds per cubic foot (pcf).

The resilience of the flexible polyurethane foam of the present disclosure may be measured in accordance with ASTM D3574 by dropping a steel ball from a reference height onto the samples and measuring a peak height of ball rebound. The peak height of ball rebound, expressed as a percentage of the reference height, is the resilience of the flexible polyurethane foam. The resilience of the flexible polyurethane foam of the present disclosure can be about 5% to about 100%, about 7% to about 80%, about 10% to about 60%, about 15% to about 40%, or about 20% to about 30%.

The indentation force deflection (IFD) may be determined in accordance with ASTM D3574. A 25% IFD is defined as an amount of force in pounds required to indent a 50 in², round indenter foot into the sample a distance of 25% of the sample's thickness. Similarly, a 65% IFD is defined as the amount of force in pounds required to indent the indenter foot into the sample a distance of 65% of the sample's thickness.

The flexible polyurethane foams of the present disclosure are also evaluated for compression set and compression force deflection (CFD), each in accordance with ASTM D3574. Compression set is a measure of permanent partial loss of original height of the flexible polyurethane foam after compression due to a bending or collapse of cellular structures within the flexible polyurethane foam. Compression set is measured by compressing the flexible polyurethane foam by 90%, i.e., to 10% of original thickness, and holding the flexible polyurethane foam under such compression at 70° C. for 22 hours. Compression set is expressed as a percentage of original compression. Finally, CFD is a measure of load-bearing performance of the flexible polyurethane foam and is measured by compressing the flexible polyurethane foam with a flat compression foot that is larger than the sample. CFD is the amount of force exerted by the flat compression foot and is typically expressed at 25%, 40%, 50%, and/or 65% compression of the flexible polyurethane foam.

The samples are tested for tensile strength and elongation in accordance with ASTM D3574. The samples are tested for tear strength in accordance with ASTM D624. Tensile strength, tear strength, and elongation properties describe the ability of the flexible polyurethane foam to withstand handling during manufacturing or assembly operations. Specifically, tensile strength is the force in lbs/in² required to stretch the flexible polyurethane foam to a breaking point. Tear strength is the measure of the force required to continue a tear in the flexible polyurethane foam after a split or break has been started, and is expressed in lbs/in (ppi). Tear strength values above 1.0 ppi are especially desirable for applications requiring the flexible polyurethane foam to be stapled, sewn, or tacked to a solid substrate, such as furniture or bedding which are comfort and support articles. Finally, elongation is a measure of the percent that the flexible polyurethane foam will stretch from an original length before breaking.

The air flow test measures the ease with which air passes through the flexible polyurethane foams. In a typical setup, the air flow test consists of placing a sample in a cavity over a chamber and creating a specified constant air-pressure differential. The air-flow value is the rate of air low, in cubic feet per minute, required to maintain the constant air-pressure differential. In a specific embodiment, the air flow value is the volume of air per second at standard temperature and pressure required to maintain a constant air-pressure differential of 125 Pa across a 2″×2″×1″ (5.08 cm×5.08 cm×2.54 cm) sample. The flexible polyurethane foam of the present disclosure can have an air flow of about 1 to about 15, about 2 to about 10, about 3 to about 9 cubic foot per minute (cfm) per square foot, as measured by the Frazier Air Permeability instrument and defined by ASTM D737.

The dynamic mechanical analysis (DMA) for Tg and Tan Delta characterizations are performed in accordance with ASTM E1640. The samples were analyzed using the dynamic temperature ramp method at a heating rate of 5° C./min, using a TA instruments RSA3 DMA. The hydrolysis resistance test is conducted in accordance with Volkswagen Group Standard PV 3959. The specimen is heat aged in a desiccator for 200 hours in a forced air oven at 90±2° C. at 100% relative humidity. The sample is pushed and the recovery time is recorded for evaluation. A recovery time of 5 seconds or less is deemed to pass the test.

Reference will now be made to specific examples illustrating the disclosure. It is to be understood that the examples are provided to illustrate exemplary embodiments and that no limitation to the scope of the disclosure is intended thereby.

### EXAMPLES

### Example 1

### Modification of T80 to Produce T69 Replacement Using Ethanol as a Capping Agent (TDI Example 1)

The reaction was set up in an oven-dried 2 L round bottom flask with 4 necks and cooled to room temperature under nitrogen. 977.60 g T80 (Lupranate®) was added to the flask at room temperature. 22.40 g ethanol was added to the flask for about 15 minutes with stirring by mechanical agitator under a condenser. A thermocouple was used to monitor the exothermic reaction and also make sure the temperature of the reaction does not exceed 40° C. during addition of ethanol. After the addition of ethanol is finished, the reaction continues until there is no exotherm detected by the thermocouple. The resulting product was transferred to a storage can.

### Example 2

### Modification of T80 Using Ethanol as a Capping Agent (TDI Example 2)

The reaction was set up in an oven-dried 2 L round bottom flask with 4 necks and cooled to room temperature under nitrogen. 861.60 g T80 (Lupranate®) was added to the flask at room temperature. 138.40 g ethanol was added to the flask for about 3 hours with stirring by mechanical agitator under a condenser. A thermocouple was used to monitor the exothermic reaction and also make sure the temperature of the reaction does not exceed 40° C. during addition of ethanol. After the addition of ethanol is finished, the reaction continues until there is no exotherm detected by the thermocouple. The resulting product was transferred to a storage can.

### Example 3

### Modification of T80 to Produce T69 Replacement Using 1-Butanol as a Capping Agent (TDI Example 3)

The reaction was set up in an oven-dried 2 L round bottom flask with 4 necks and cooled to room temperature under nitrogen. 970.20 g T80 (Lupranate®) was added to the flask at room temperature. 29.82 g 1-butanol was added to the flask for about 1 minute with stirring by mechanical agitator under a condenser. A thermocouple was used to monitor the exothermic reaction and also make sure the temperature of the reaction does not exceed 40° C. during addition of 1-butanol. After the addition of 1-butanol is finished, the reaction continues until there is no exotherm detected by the thermocouple. The resulting product was transferred to a storage can.

### Example 4

### Modification of T80 Using 1-Butanol as a Capping Agent (TDI Example 4)

The reaction was set up in an oven-dried 2 L round bottom flask with 4 necks and cooled to room temperature under nitrogen. 816.10 g T80 (Lupranate®) was added to the flask at room temperature. 184.08 g 1-butanol was added to the flask for about 30 minute with stirring by mechanical agitator under a condenser. A thermocouple was used to monitor the exothermic reaction and also make sure the temperature of the reaction does not exceed 40° C. during addition of 1-butanol. After the addition of 1-butanol is finished, the reaction continues until there is no exotherm detected by the thermocouple. The resulting product was transferred to a storage can.

### Example 5

### Modification of T80 to Produce T69 Replacement Using Methanol as a Capping Agent (TDI Example 5)

The reaction was set up in an oven-dried 2 L round bottom flask with 4 necks and cooled to room temperature under nitrogen. 977.60 g T80 (Lupranate®) was added to the flask at room temperature. 15.60 g methanol was added to the flask for about 15 minutes with stirring by mechanical agitator under a condenser. A thermocouple was used to monitor the exothermic reaction and also make sure the temperature of the reaction does not exceed 40° C. during addition of methanol. After the addition of methanol is finished, the reaction continues until there is no exotherm detected by the thermocouple. The resulting product was transferred to a storage can.

TABLE 1
Gas Chromatography (GC) results of the original and modified TDI isomer mixtures.

| | T80 | TDI | TDI | TDI | TDI | TDI |
|---|---|---|---|---|---|---|
| | (Lupranate ®) | Example 1 | Example 2 | Example 3 | Example 4 | Example 5 |
| 2,4-TDI (wt %) | 78.3 | 69.0 | 24.8 | 69.0 | 40.3 | 69.1 |
| 2,6-TDI (wt %) | 21.0 | 20.0 | 14.6 | 19.9 | 15.1 | 20.2 |
| Other | 0.7 | 10.92 | 60.65 | 11.11 | 44.59 | 10.8 |
| 2,4-TDI/2,6- | 3.73 | 3.45 | 1.70 | 3.47 | 2.67 | 3.42 |
| TDI ratio | | | | | | |

Ethanol (TDI examples 1 and 2), 1-butanol (TDI examples 3 and 4), and methanol (TDI example 5) are used as capping agents to modify T80 (80% 2,4-TDI, 20% 2,6-TDI). The purpose of TDI examples 1, 3, and 5 are obtain a modified TDI mixture with about 69 wt % 2,4-TDI, which is a typical TDI isomer mixture used in the commercial production of flexible PU foam. As shown by the GC results in Table 1, all the examples 1, 3 and 5 provide a modified TDI mixture with 69 wt % 2,4-TDI. Currently in industry T80 and expensive T65 are mixed To obtain such a TDI mixture with about 69% 2,4-TDI, using about 22 wt % T80 and 78 wt % T65. Surprisingly, the modified T80 by capping agent in the current disclosure provides an economic replacement of the T80/T65 mixture used in the industry. TDI example 5 with methanol capping is used to manufacture flexible foams samples for testing.

### Example 6

### Manufacture of Flexible Polyurethane Foam Using Methanol-Modified TDI Mixture

Polyol is measured by weight in a single-use plastic concrete cylinder mold. The unmixed blend is set aside until later in the procedure. Any isocyanates necessary for the formulation are measured in a disposable 450 mL plastic beaker. T80 is measured by volume and all other isocyanates are measured by weight via lab benchtop scale. The measured isocyanate is set aside in a fume hood until it is to be mixed with the polyol blend. The previously-weighed polyol components are mixed using a drill press equipped with a German mix blade at 250-300 rpm for 2 mins. The cup is rotated in the opposite direction of the mix head spin for better mixing. During this process, great care is taken to make sure the mix head remains completely submerged, which reduces air inclusion in the mixture. At the 2-min mark the isocyante is quickly poured into the polyol blend and the mix speed is immediately increased to 1800 rpm. After 8 seconds of mixing the reacting mixture is quickly poured into a labeled 5 gallon (18.93 L) pail liner (13″ height×11″ diameter, 33.02 cm height×27.94 cm diameter). The foam is allowed to rise completely before the sample is put in an oven at 115° C. for 15 mins. The cream time and rise time are measured during this step if such information is desired. The samples are removed and placed in a well-ventilation cabinet or fume hood overnight. The following day, the pail liner is cut off with a retractable knife. The foam buns are cut to size for physical testing using a band saw. 1.5″ is cut from the flat bottom of each bun. The remaining foam is cut into as many 4″ thick sections as possible. After cutting the foams are placed back in a ventilated cabinet or fume hood and left overnight to air out. The following day the samples are submitted for physical testing. Comparative Example 1 uses 218.4 g of T80 and T65. Comparative Example 2 uses 218.4 g of T80. Foam Example 1 uses 218.4 g of methanol-modified T80 (TDI Example 5). Foam Example 2 uses 238.74 g of methanol-modified T80 (TDI Example 5).

TABLE 2
Formulations of PU flexible foams.

| | Comparative | Comparative | Foam | Foam |
|---|---|---|---|---|
| | Example 1 | Example 2 | Example 1 | Example 2 |
| Polyol | 100 | 100 | 100 | 100 |
| (Lupraphen ® | | | | |
| 2602) | | | | |
| T80 | 8 | 36.4 | — | — |
| (Lupranate ®) | | | | |
| T65 | 28.4 | — | — | — |
| (Desmodur ®) | | | | |
| TDI Index | 107.0 | 107.0 | — | — |
| Modified T80 | — | — | 36.4 | 39.8 |
| Catalyst | 0.5 | 0.5 | 0.5 | 0.5 |
| (Dabco ® NE400) | | | | |
| Surfactant | 1.0 | 1.0 | 1.0 | 1.0 |
| (Tegostab ® | | | | |
| B8330) | | | | |
| Emulsifier | 0.5 | 0.5 | 0.5 | 0.5 |
| (Tegostab ® | | | | |
| B8315) | | | | |
| Blowing agent | 2.5 | 2.5 | 2.5 | 2.5 |
| (water) | | | | |

Table 2 illustrates the formulations of the PU flexible foams tested in the present disclosure. Comparative Example 1 uses a convention T69 mixture which mixes 8 weight units of T80 and 28.4 weight units of T65. Comparative Example 2 uses 100% (36.4 weight units) T80 isocyanate. Foam Examples 1 and 2 are in accordance with embodiments of the present disclosure using methanol-modified isocyanate as T69 replacement. Foam Example 1 matches the isocyanate amount in the comparative examples, foam Example 2 increases the isocyanate loading slightly to account for the NCO lost during capping process.

TABLE 3
Physical properties of the PU flexible foams.

| | | | Comparative | Comparative | Foam | Foam |
|---|---|---|---|---|---|---|
| | | Test Method | Example 1 | Example 2 | Example 1 | Example 2 |
| Density (pcf) | | ASTM D1622 | 2.53 | 2.51 | 2.73 | 2.68 |
| Elongation (%) | | ASTM D3574 | 141 | 132 | 212 | 163 |
| Tensile (psi) | | ASTM D3574 | 19 | 18 | 20 | 21 |
| Tear (Split Tear, pi) | | ASTM D624 | 2.0 | 2.0 | 2.7 | 2.5 |
| Resiilence (%) | | ASTM D3574 | 24 | 22 | 21 | 23 |
| IFD | 25% IFD (lbf) | ASTM D3574 | 49 | 48 | 36 | 41 |
| 50 in² | 25% IFD (return) | | 32 | 30 | 23 | 28 |
| (4 in.) | 65% IFD (lbf) | | 136 | 184 | 109 | 114 |
| | Support Factor | | 2.8 | 3.9 | 3.0 | 2.8 |
| | Recovery, % | | 64 | 63 | 65 | 68 |

| | | | | | |
|---|---|---|---|---|---|
| Air Flow (Frazier, cfm/ft²) | ASTM D737 | 11.2 | 2.2 | 4.8 | 12.5 |
| Compression Set, 50% | ASTM D3574 | 10.5 | 10.3 | 7.4 | 8.4 |
| Recovery Time, seconds | ASTM D3574 | 6 | 6 | 14 | 7 |
| DMA, Tg (° C.) | ASTM E1640 | −18 | −19 | −20 | −17 |
| DMA, Tan Delta (° C.) | | −10 | −9 | −11 | −7 |

Table 3 illustrates the physical properties of PU flexible foams. The flexible PU foam using the modified T80 mixture (Foam Example 2) provides similar or even better foam properties compared to the T80/T65 mixture (Comparative Example 1). The elongation of Foam Example 2 increases by 15%, tensile strength is improved over 10%, tear strength increases by 25%, while the compression set results showed a slight enhancement in comparison to the properties of Comparative Example 1. The tensile and compression characteristics for the foam generated utilizing the modified TDI have all improved. In contrast, the measurements of Comparative Example 2 have demonstrated either no improvement or a slight decrease in tensile strength and compression set. The resilience and density for Foam Example 2 are essentially similar with Comparative Example 1 as well, only showing a decrease of −4% and increase of −6% respectively. Also, take the air flow property as an example, conventional T80/T65 mixture leads to a flexible foam with an air flow of 11.2 cfm/ft² in Comparative Example 1. Comparative Example 2 with 100% T80 has an air flow of 2.2 cfm/ft², illustrating the advantage of having higher proportion of 2,6-TDI. With a relatively higher TDI index to compensate for the NCO loss during capping process, Foam Example 2 provides a comparative air flow data at 12.5 cfm/ft².

Those skilled in the art will recognize, or be able to ascertain, using no more than routine experimentation, numerous equivalents to the specific composition and procedures described herein. Such equivalents are considered to be within the scope of this disclosure, and are covered by the following claims.

What is claimed is:

1. A method of producing polyurethane, the method comprising:
modifying a 2,4-toluene diisocyanate (2,4-TDI) and 2,6-toluene diisocyanate (2,6-TDI) mixture using a capping agent; and
reacting the modified 2,4-TDI and 2,6-TDI mixture with an isocyanate-reactive component,
wherein the capping agent comprises a monoalcohol, a monoamine or a monothiol.

2. The method of claim 1, wherein the ratio of 2,4-TDI to 2,6-TDI in the mixture before modification is about 65 to 35 or about 80 to 20.

3. The method of claim 1, wherein the capping agent is selected from the group consisting of methanol, ethanol, 1-propanol, isopropanol, 1-butanol, 2-butanol, 1-pentanol, 2-pentanol, 1-hexanol, 2-hexanol, cyclohexanol, 1-heptanol, 2-heptanol, 1-octanol, 2-octanol, 1-nonanol, 1-decanol, 1-undecanol, and 1-dodecanol.

4. The method of claim 1, wherein the capping agent comprises methanol.

5. The method of claim 1, wherein the isocyanate-reactive component is selected from the group consisting of polyether polyol, a polyester polyol, and combinations thereof.

6. A polyurethane produced by a method comprising:
modifying a 2,4-toluene diisocyanate (2,4-TDI) and 2,6-toluene diisocyanate (2,6-TDI) mixture using a capping agent; and
reacting the modified 2,4-TDI and 2,6-TDI mixture with an isocyanate-reactive component,
wherein the capping agent comprises a monoalcohol, a monoamine or a monothiol.

7. The polyurethane of claim 6, wherein the ratio of 2,4-TDI to 2,6-TDI in the mixture before modification is about 65 to 35 or about 80 to 20.

8. The polyurethane of claim 6, wherein the capping agent is selected from methanol, ethanol, 1-propanol, isopropanol, 1-butanol, 2-butanol, 1-pentanol, 2-pentanol, 1-hexanol, 2-hexanol, cyclohexanol, 1-heptanol, 2-heptanol, 1-octanol, 2-octanol, 1-nonanol, 1-decanol, 1-undecanol, and 1-dodecanol.

9. The polyurethane of claim 6, wherein the capping agent is methanol.

10. The polyurethane of claim 6, wherein the isocyanate-reactive component is selected from a polyether polyol, a polyester polyol, and combinations thereof.

11. A method of modifying a 2,4-toluene diisocyanate (2,4-TDI) and 2,6-toluene diisocyanate (2,6-TDI) mixture, the method comprising:
reacting a capping agent with the 2,4-TDI and 2,6-TDI mixture,
wherein the capping agent comprises a monoalcohol, a monoamine or a monothiol.

12. The method of claim 11, wherein the ratio of 2,4-TDI to 2,6-TDI in the mixture before modification is about 65 to 35 or about 80 to 20.

13. The method of claim 11, wherein the capping agent is selected from methanol, ethanol, 1-propanol, isopropanol, 1-butanol, 2-butanol, 1-pentanol, 2-pentanol, 1-hexanol, 2-hexanol, cyclohexanol, 1-heptanol, 2-heptanol, 1-octanol, 2-octanol, 1-nonanol, 1-decanol, 1-undecanol, and 1-dodecanol.

14. The method of claim 11, wherein the capping agent is methanol.

15. The method of claim 11, wherein the isocyanate-reactive component is selected from a polyether polyol, a polyester polyol, and combinations thereof.

16. The method of claim 11, which is carried out in the absence of any solvent other than the TDI mixture and capping agent.

17. A modified 2,4-toluene diisocyanate (2,4-TDI) and 2,6-toluene diisocyanate (2,6-TDI) mixture, produced by a method comprising reacting a capping agent comprising a monoalcohol, a monoamine or a monothiol with the 2,4-TDI and 2,6-TDI mixture.

18. The modified 2,4-TDI and 2,6-TDI mixture of claim 17, wherein the ratio of 2,4-TDI to 2,6-TDI in the mixture before modification is about 65 to 35 or about 80 to 20.

19. The modified 2,4-TDI and 2,6-TDI mixture of claim 17, wherein the capping agent is selected from the group consisting of methanol, ethanol, 1-propanol, isopropanol, 1-butanol, 2-butanol, 1-pentanol, 2-pentanol, 1-hexanol, 2-hexanol, cyclohexanol, 1-heptanol, 2-heptanol, 1-octanol, 2-octanol, 1-nonanol, 1-decanol, 1-undecanol, and 1-dodecanol.

20. The modified 2,4-TDI and 2,6-TDI mixture of claim 17, wherein the isocyanate-reactive component is selected from the group consisting of polyether polyol, a polyester polyol, and combinations thereof.
